(19) United States
(12) Patent Application Publication
(10) Pub. No.: US 2011/0108274 A1
(43) Pub. Date: May 12, 2011

(54) ADDITIVE FOR WELL CEMENTING APPLICATIONS

(75) Inventors: Jean-Philippe Caritey, Le Plessis Robinson (FR); Sylwia Komocki, Chatenay Malabry (FR); Michel Michaux, Verrieres-Le-Buisson (FR); Tatiana Pyatina, Bures Sur Yvette (FR)

(73) Assignee: Schlumberger Technology Corporation, Sugar Land, TX (US)

(21) Appl. No.: 12/912,707

(22) Filed: Oct. 26, 2010

(30) Foreign Application Priority Data
Nov. 6, 2009 (EP) 09290852.4

(51) Int. Cl. E21B 33/13; C09K 8/46; C09K 8/467

(52) U.S. Cl. 166/293; 106/713; 106/606; 106/728; 106/729

(57) ABSTRACT

An additive for Portland-cement slurries comprises a liquid silicate absorbed into a solid porous medium. The additive is incorporated in slurries designed for well-cementing applications. The liquid silicate functions as a retarder aid and dispersant when added to slurries for use at temperatures above about 85° C. The resulting solid product allows use of the liquid silicate in well-cementing operations as if it were a dry additive.

### BACKGROUND OF THE INVENTION

The statements in this section merely provide background information related to the present disclosure and may not constitute prior art.

Some embodiments of the invention broadly relates to well cementing; and more particularly, to a cement additive, the use of the cement additive and related methods.

Cement slurries employed in well-cementing operations typically comprise Portland cement as a hydraulic binder. When water is added to the cement to form a slurry, hydration reactions occur that cause the slurry to initially gel and then harden to a solid over time. Well cementing generally involves preparing the slurry at the surface, and the slurry frequently contains liquid or solid additives that modify its chemical behavior and/or physical properties.

Retarders are additives that slow the hydration process, extending the time during which the slurry is pumpable. Delaying the setting time of a Portland-cement slurry becomes more difficult as well temperatures increase. In response, the industry has developed powerful retarders. However, the performance of these retarders can be unpredictable. Small retarder-concentration variations may cause large thickening-time fluctuations and affect the time at which strength begins to develop. For high-temperature wells, retarders are often supplemented with “retarder enhancers” such as boric acid and sodium borate (borax). Unfortunately, these chemicals are not always compatible with other high-temperature additives, causing difficulties with fluid-loss control and rheological properties. Therefore, there is an incentive to develop solutions for these problems.

FR 2,667,058 describes the use of silicates in retarded cement slurries for tie-back applications (i.e., when it is desired that the cement sheath extends all the way from the bottom of the well to the surface). In this application, a retarder based on a glucoheptonate salt is used to retard cement slurries at higher bottomhole temperatures. Relatively large quantities of sodium silicate (17.75 L/metric ton of cement) are included in the slurry to ensure that the slurry sets near the surface, at which the temperature is relatively low. Patent application WO 2005/024175 describes the use of nanosilica and alkali silicates as retarder enhancers at higher temperatures. These references are included herein by reference thereto.

Another common difficulty encountered in the context of well cementing is the variability of cement reactivity. Cement reactivity largely establishes how quickly a cement slurry will set, and it may also affect the rheological properties of the slurry. The well-cementing industry has established classification systems that provide a general indication of Portland-cement reactivity and suitability for a given cementing application. One classification system is that of the American Petroleum Institute (API). This system has also been adopted by the International Organization for Standardization (ISO), and is described in ISO Publication 10426-1, incorporated herein. Portland cements meeting the API/ISO requirements are often more expensive than those manufactured for construction applications. Construction cements may be appropriate for low temperature applications; however, they are often not sufficiently reliable in higher temperature applications. Their physical and compositional variability leads to unpredictable performance. Moreover, the response of construction cements to additives is usually unpredictable, further increasing the risk of encountering difficulties during the cementing process. Therefore, there has been a need to find ways by which construction cements may be used in elevated-temperature applications.

WO 2007/048560, incorporated herein, disclosed that retarder enhancement and reduced sensitivity to cement variability could be achieved by the addition of certain sodium silicates. At temperatures above about 85° C., Portland cement slurries containing these silicates exhibited improved rheological properties—that is, the tendency of the slurry to gel prematurely was reduced significantly. In addition, lower retarder concentrations were required to achieve a given thickening time. The inventors suggested that the improvement arises from the release of polysilicate anions into the aqueous phase of the slurry, which in turn control the behavior of the interstitial phases of Portland cement—tricalcium aluminate and tetracalcium aluminoferrite. The inventors also showed that the physical state of the sodium silicate was important. Concentrated liquid sodium polysilicates were significantly more efficient than solid ones with the same SiO₂:Na₂O ratio.

Solid additives are often more suitable logistically than liquid ones. It is frequently more efficient to dry blend solid additives with the cement and transport the mixture to the wellsite. The dry blend is then simply mixed with water at the wellsite. Liquid additives require additional metering equipment at the wellsite, increasing the complexity of the operation. The liquid silicates could be added to the mix water at some time prior to cement-slurry preparation; however, aging of the silicate solution often leads to unpredictable performance. This is primarily attributed to a depolymerization of silicate anions when the concentrated silicate solution is diluted. The rheological properties may be impaired, and the thickening time may be significantly shorter than that observed when the silicates are added at the moment of slurry preparation. Additionally, in cold climates, many liquid additives may become unpumpable unless special heating facilities are available.

It therefore remains desirable to provide a sodium silicate additive that performs as well as a liquid version, yet can be added as a solid.

### SUMMARY

Embodiments relate to additives for cement slurries comprising liquid silicates absorbed into a porous solid-support medium, allowing the liquid to be added as if it were a solid. The silicates have the general formula (SiO₂)ₓ(M₂O), where M represents an alkali metal. The SiO₂:M₂O molar ratio is preferably greater than 1.5, and most preferably in the range between 1.7 and 3.4. Suitable porous support media include (but are not limited to) silicon dioxide, diatomaceous earth, zeolites and organic polymers.

Further, embodiments pertain to methods using the additives, for the purpose of improving the properties of cement slurries comprising Portland cement. Additionally, the cement slurry may comprise one or more cement retarders chosen from the list comprising gluconate salts, glucoheptonate salts, hydroxycarboxylic acids, hydroxycarboxylic salts, unrefined lignosulfonates, refined lignosulfonates, lignin-amine derivatives, AMPS-acrylic acid polymers and AMPS-itaconic acid polymers.

Yet further, embodiments aim at methods of preparing a cement slurry comprising Portland cement and the additives mentioned herein. The additives are incorporated into the cement slurry at a concentration preferably between about 0.1% to about 20% by weight of cement. Upon slurry preparation, the silicate flows out of the porous medium and disperses into the liquid phase of the slurry. In addition to the inventive additive, the cement slurry may comprise one or more cement retarders chosen from the list comprising gluconate salts, glucoheptonate salts, hydroxycarboxylic acids, hydroxycarboxylic salts, unrefined lignosulfonates, refined lignosulfonates, lignin-amine derivatives, AMPS-acrylic acid polymers and AMPS-itaconic acid polymers.

Further, embodiments relate to methods of cementing a subterranean zone penetrated by a wellbore, at temperatures above about 85° C. The methods involve preparing a slurry comprising Portland cement and the additives described herein into the cement slurry. The additive concentration is preferably between about 0.1% to about 20% by weight of cement. Upon slurry preparation, the silicate flows out of the porous medium and disperses into the liquid phase of the slurry. The slurry containing the additive is placed into the subterranean wellbore, whereupon the slurry sets and hardens. Additionally, one may add one or more cement retarders chosen from the list comprising gluconate salts, glucoheptonate salts, hydroxycarboxylic acids, hydroxycarboxylic salts, unrefined lignosulfonates, refined lignosulfonates, lignin-amine derivatives, AMPS-acrylic acid polymers and AMPS-itaconic acid polymers.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The performance of alkali silicates as gel inhibitors and retarder aids in Portland cement slurries depends on their SiO₂:Na₂O ratio and their physical state. The silicates release polysilicate anions, which in turn decrease the hydration rate of the interstitial phases in Portland cement—tricalcium aluminate and tetracalcium aluminoferrite. This controlling effect is evident and useful at slurry temperatures above about 85° C. Liquid silicates perform better than their solid counterparts at the same SiO₂:Na₂O ratio. However, there are circumstances when the use of liquid additives is not practical.

The inventors have surprisingly discovered that absorbing liquid sodium silicates into a porous medium creates a solid additive that performs as well as the liquid. Suitable porous media include (but are not limited to) silicon dioxide, diatomaceous earth, zeolites and organic polymers. Therefore, embodiments relate to an additive for cement slurries comprising Portland cement. The additive comprises liquid silicates absorbed into a porous solid support medium such as those described above, allowing the liquid to be added as if it were a solid. The silicates have the general formula (SiO₂)ₓ(M₂O), where M represents an alkali metal. The SiO₂:M₂O molar ratio is preferably greater than 1.5, and most preferably in the range between 1.7 and 3.4.

The cement slurry according to the various embodiments disclose is preferably a pumpable cement slurry which is to say a slurry having a rheology equal or lesser than 300 cP.

Further, embodiments pertain to methods using the additive for the purpose of improving the properties of cement slurries comprising Portland cement. Additionally, the cement slurry may comprise one or more cement retarders chosen from the list comprising gluconate salts, glucoheptonate salts, hydroxycarboxylic acids, hydroxycarboxylic salts, unrefined lignosulfonates, refined lignosulfonates, lignin-amine derivatives, AMPS-acrylic acid polymers and AMPS-itaconic acid polymers.

Yet further, embodiment aim at methods of preparing a cement slurry comprising Portland cement and the additive comprising liquid silicates absorbed into a porous solid support medium. The additive is incorporated into the cement slurry at a concentration preferably between about 0.1% to about 20% by weight of cement. In addition to the inventive additive, the cement slurry may comprise one or more cement retarders chosen from the list comprising gluconate salts, glucoheptonate salts, hydroxycarboxylic acids, hydroxycarboxylic salts, unrefined lignosulfonates, refined lignosulfonates, lignin-amine derivatives, AMPS-acrylic acid polymers and AMPS-itaconic acid polymers.

Further, embodiments relate to methods of cementing a subterranean zone penetrated by a wellbore, at temperatures above about 85° C. The method involves preparing a slurry comprising Portland cement and the additive comprising liquid silicates absorbed into a porous solid support medium. The additive is incorporated into the cement slurry at a concentration preferably between about 0.1% to about 20% by weight of cement. Upon slurry preparation, the silicate flows out of the porous medium and disperses into the liquid phase of the slurry. The slurry containing the additive is placed into the subterranean wellbore, whereupon the slurry sets and hardens. Additionally, one may add one or more cement retarders chosen from the list comprising gluconate salts, glucoheptonate salts, hydroxycarboxylic acids, hydroxycarboxylic salts, unrefined lignosulfonates, refined lignosulfonates, lignin-amine derivatives, AMPS-acrylic acid polymers and AMPS-itaconic acid polymers.

### EXAMPLES

Some embodiments of the invention may be further understood from the following examples.

The performance of different sodium silicates was tested in Portland cement slurries heated to 85° C. The tests involved two API/ISO cements, Dyckerhoff “Black Label” Class G and Tourah Class G (supplied by Italcementi). Slurries prepared from these cements were retarded by an unrefined lignosulfonate that contains some residual sugars.

The compositions of sodium silicates employed in the examples are given in Table 1. S1 is a liquid sodium polysilicate with an SiO₂:Na₂O molar ratio of 3.4. S2 is solid sodium metasilicate, Na₂SiO₃, with the SiO₂:Na₂O molar ratio of 1.

S3 is the same liquid silicate as S1, absorbed into porous silicon dioxide. The porous silica was Tixosil™ 38 AB, available from Rhodia. The additive was prepared as follows. 200 g of the liquid sodium silicate were poured dropwise over 100 g of porous silica while mixing continuously with a spatula. Then, the mixture was placed in a Waring blender and homogenized at 16,000 RPM for 1 minute. The homogenized mixture passed through a 0.4-mm sieve. Oversized powder was ground further until it passed through the sieve.

The fourth and fifth silicates (S4 and S5) are solids with SiO₂:Na₂O molar ratios of 3.3 and 2.1, respectively. Both S4 and S5 contain 19 wt. % of crystallization water, while S2 is in anhydrous form.

TABLE 1
Compositions and forms of sodium silicates.

| | | SiO₂ | Na₂O | SiO₂:Na₂O |
|---|---|---|---|---|
| Additive | Form | (wt. %) | (wt. %) | molar ratio |
| S1 | Liquid | 29.5 | 9.0 | 3.4 |
| S2 | Solid | 48.3 | 51.7 | 1.0 |
| S3 | Liquid absorbed | 19.7 | 6.0 | 3.4 |
| | into inert support* | | | |
| S4 | Solid** | 61.8 | 19.2 | 3.3 |
| S5 | Solid** | 54.0 | 27.0 | 2.1 |

*Same liquid silicate as S1 absorbed into porous silicon dioxide. The bulk composition of the solid additive is 33 wt. % porous silicon dioxide, 41 wt. % water, 25.7 wt. % silicate. This is the current invention.
**These solid sodium silicates contain 19 wt. % water.

The cement slurries were prepared according to API/ISO specifications. The mixing procedure is published in ISO Publication 10426-2. The cement slurries were prepared with tap water, and the slurry density was 1890 kg/m³. Solid silicates S2, S3, S4 and S5 were dry blended with the cement prior to mixing with water, whereas the liquid silicate S1 was added to the mix water just prior to slurry preparation. To prevent excessive foam development during mixing, the slurries also contained a silicone antifoam agent at a concentration of 2.66 L/metric ton of cement.

Thickening time and rheology tests were conducted according to API/ISO procedures. The thickening time was taken as the time necessary for the slurry to attain a consistency of 100 Bearden units (Bc). The testing procedures are published in ISO Publication 10426-2, incorporated herein. The thickening-time schedule employed in the examples is shown in Table. 2. Rheological measurements were performed with a couette-type rotational viscometer after the slurries were conditioned for 20 minutes in an atmospheric consistometer, rotating at 150 RPM. The slurry temperature was 85° C.

TABLE 2
Schedule for thickening time tests reported in Tables 5 and 6

| Initial | Final | | | Time to | Heating |
|---|---|---|---|---|---|
| Tempera- | Tempera- | Initial | Final | T/P | rate |
| ture (° C.) | ture (° C.) | Pressure | Pressure | (min) | (° C./min) |
| 27 | 85 | 10 MPa | 70 MPa | 44 | 1.32 |
| | | (1,500 psi) | (10,200 psi) | | |

### Example 1

Six cement slurries were prepared. The cement was Dyckerhoff “Black Label” Class G. One control slurry did not contain a silicate additive. The other five involved each of the silicates described In Table 1. Each silicate was added at a concentration corresponding to the same SiO₂ content (0.185% by weight of cement [BWOC]). The retarder concentration in all cases was 0.8% BWOC. The rheological measurements are shown in Table 3.

TABLE 3
Effect of different sodium silicates on rheologies of slurries prepared
with Dyckerhoff “Black Label” Class G cement.

| Formulation | A | B | C | D | E | F |
|---|---|---|---|---|---|---|
| S1, L/metric ton | — | 4.44 | — | — | — | — |
| S2, % BWOC* | — | — | 0.38 | — | — | — |
| S3, % BWOC | — | — | — | 0.8 | — | — |
| S4, % BWOC | — | — | — | — | 0.3 | — |
| S5, % BWOC | — | — | — | — | — | 0.34 |

API (ramp down) rheometer readings at 85° C.

| | | | | | | | |
|---|---|---|---|---|---|---|---|
| 300 | rpm | Slurry too | 68 | Slurry too | 76 | 129 | Slurry too |
| 200 | rpm | viscous to | 46 | viscous to | 55 | 90 | viscous to |
| 100 | rpm | acquire | 24 | acquire | 32 | 50 | acquire |
| 60 | rpm | measurements. | 15 | measurements. | 21 | 32 | measurements. |
| 30 | rpm | | 8 | | 12 | 18 | |
| 6 | rpm | | 2 | | 4 | 6 | |
| 3 | rpm | | 1 | | 3 | 4 | |

*BWOC is an acronym for “by weight of cement”

In the absence of silicates (Formulation A), the slurry was so viscous that rheological measurements could not be recorded. Similar behavior was observed when solid silicates S2 and S5 were added (Formulations C and F). Addition of liquid silicate 51 (Formulation B) and the same liquid silicate adsorbed into porous silicon dioxide S3 (Formulation D) provided a strong dispersing effect. A lesser dispersing effect was observed when solid silicate S4 was added (Formulation E).

### Example 2

Rheological tests similar to those reported in Example 1 were performed with Dyckerhoff “Black Label” Class G cement. However, the silicate concentration was increased such that the amount of added SiO₂ was 0.28% BWOC for each formulation. The rheological measurements are shown in Table 4.

TABLE 4
Effect of different sodium silicates on rheologies of slurries prepared
with Dyckerhoff “Black Label” Class G cement.

| Formulation | G | H | J |
|---|---|---|---|
| S2, % BWOC | 0.57 | — | — |
| S3, % BWOC | — | 1.2 | — |
| S4, % BWOC | — | — | 0.45 |

API (ramp down) rheometer readings at 85° C.

| | | | |
|---|---|---|---|
| 300 rpm | Viscous slurry, | 77 | 80 |
| 200 rpm | measurements | 52 | 55 |
| 100 rpm | impossible | 26 | 29 |
| 60 rpm | | 16 | 18 |
| 30 rpm | | 8 | 9 |
| 6 rpm | | 2 | 3 |
| 3 rpm | | 1 | 2 |

At the higher sodium-silicate concentrations, the slurry containing silicate S2 was still too viscous to perform rheological measurements (Formulation G). Higher concentrations of silicates S3 and S4 (Formulations H and J, respectively) resulted in a higher degree of dispersion compared to their counterparts in Example 1 (Formulations D and E).

### Example 3

Thickening-time tests were conducted according to the schedule shown in Table 2. The cement was Tourah Class G. One control slurry did not contain a silicate additive. The other five involved each of the silicates described In Table 1. Each silicate was added at a concentration corresponding to the same SiO₂ content (0.185% BWOC). The lignosulfonate-retarder concentration in all cases was 0.5% BWOC. The thickening-time measurements are shown in Table 5.

TABLE 5
Effect of different silicates on thickening times
of slurries prepared with Tourah Class G Cement.

| Formulation | K | L | M | N | P |
|---|---|---|---|---|---|
| S1, L/metric ton | — | 4.44 | — | — | — |
| S2, % BWOC | — | — | 0.38 | — | — |
| S3, % BWOC | — | — | — | 0.8 | — |
| S4, % BWOC | — | — | — | — | 0.3 |

Thickening Time at 85° C.

| | | | | | |
|---|---|---|---|---|---|
| 100 Bc, hr:min | 4:16 | 5:18 | 3:12 | 6:08 | 4:07 |

The thickening time of the control slurry (Formulation K) was 4 hr, 16 min. The thickening time was shortened when solid silicate S2 was added (Formulation M), and was practically the same when solid silicate S4 was added (Formulation P). The thickening times were significantly lengthened when liquid silicate S1 and the same liquid silicate absorbed into porous silicon dioxide S3 were added (Formulations L and N, respectively).

### Example 4

Thickening-tests similar to those presented in Example 3 were performed. The sodium silicate concentration was increased by 40%. The thickening-time measurements are shown in Table 6.

TABLE 6
Effect of different silicates on thickening times
of slurries prepared with Tourah Class G cement.

| Formulation | Q | R | S | T | U |
|---|---|---|---|---|---|
| S1, L/metric ton | 6.22 | — | — | — | — |
| S2, % BWOC | — | 0.53 | — | — | — |
| S3, % BWOC | — | — | 1.12 | — | — |
| S4, % BWOC | — | — | — | 0.42 | — |
| S5, % BWOC | — | — | — | — | 0.47 |

Thickening time at 85° C.

| | | | | | |
|---|---|---|---|---|---|
| 100 Bc, hr:min | 5:57 | 3:06 | 6:34 | 4:19 | 3:30 |

Compared to Example 3, significant thickening-time extension was observed with higher concentrations of liquid silicate S1 (Formulation Q) and the same liquid silicate absorbed into porous silicon dioxide (Formulation S). No significant thickening-time changes were observed when the other silicates were added at higher concentrations (Formulations R and T).

All the above examples show that the presently claimed additive comprising liquid silicates absorbed into a porous solid support material, silicate S3, performs in a superior manner. Indeed, S3 is equivalent to its liquid counterpart, silicate S1 in many aspect but also combines some advantages that a solid silicate may have. Still it has to be notice that liquid silicate absorbed on a porous solid support material performs better than solid silica in many aspects such as for example the dispersing effect. Accordingly, having a liquid silicate absorbed on a liquid porous medium allows better performance than liquid or solid silicate.

1. A pumpable cement slurry comprising Portland cement and an additive comprising liquid silicates absorbed into a porous solid support material.

2. The composition of claim 1, wherein the additive releases polysilicate anions.

3. The composition of claim 1, wherein the silicates comprise alkali metal silicates of the general formula (SiO₂)ₓ(M₂O), wherein M is an alkali metal.

4. The composition according to claim 3, wherein the SiO₂:M₂O molar ratio of the absorbed silicate is greater than about 1.5.

5. The composition according to claim 3, wherein the SiO₂:M₂O molar ratio of the absorbed silicate is in the range from about 1.7 to about 3.4.

6. The composition according to claim 1, wherein the solid support material comprises one or more members of the list comprising silicon dioxide, diatomaceous earth, zeolites and organic polymers.

7. The composition according to claim 1, wherein the additive is added at a concentration in the range of about 0.1% to about 20% by weight of cement.

8. The composition of claim 1, wherein the rehology of the cement slurry is lesser than or equal to about 300 cP.

9. A method of preparing a cement slurry comprising Portland cement, comprising:
i. providing a hydraulic cement comprising Portland cement,
ii. combining an additive comprising liquid silicates absorbed into a porous solid support material with the cement slurry in an amount in the range of about 0.1% to about 20% by weight of cement; and
iii. allowing the silicate within the porous medium to flow out of the porous medium and into the liquid phase of the cement slurry.

10. The method of claim 9, further comprising adding a retarder comprising at least one of the members of the list comprising: gluconate salts, glucoheptonate salts, hydroxycarboxylic acids, hydroxycarboxylic salts, unrefined lignosulfonates, refined lignosulfonates and lignin amine derivatives.

11. The method of claim 9, wherein adding the additive to the cement slurry improves the dispersing effect.

12. The method of claim 9, wherein adding the additive to the cement slurry has a retarding effect on the setting time of said cement slurry.

13. The method of claim 9, wherein the additive releases polysilicate anions.

14. The method of claim 9, wherein the silicates comprise alkali metal silicates of the general formula (SiO₂)ₓ(M₂O), wherein M is an alkali metal.

15. The method of claim 9, wherein the rheology of the cement slurry is lesser than or equal to about 300 cP.

16. A method of cementing a subterranean zone penetrated by a wellbore at a temperature above about 85° C., comprising:
i. preparing a cement slurry comprising Portland cement;
ii. combining an additive comprising liquid silicates absorbed into a porous solid support material with the cement slurry in an amount in the range of about 0.1% to about 20% by weight of cement;
iii. allowing the silicate within the porous medium to flow out of the porous medium and into the liquid phase of the cement slurry;
iv. placing the slurry containing the additive into the subterranean wellbore; and
v. allowing the slurry to set and harden.

17. The method of claim 16, further comprising adding a retarder comprising at least one of the members of the list comprising: gluconate salts, glucoheptonate salts, hydroxycarboxylic acids, hydroxycarboxylic salts, unrefined lignosulfonates, refined lignosulfonates and lignin amine derivatives.

18. The method of claim 16, wherein the additive releases polysilicate anions.

19. The method of claim 16, wherein the silicates comprise alkali metal silicates of the general formula (SiO₂)ₓ(M₂O), wherein M is an alkali metal.

20. The method of claim 16, wherein the rheology of the cement slurry is lesser than or equal to about 300 cP.
